(19) United States
(12) Patent Application Publication
(10) Pub. No.: US 2012/0223960 A1
(43) Pub. Date: Sep. 6, 2012

(54) IMAGE CONTROL METHOD AND IMAGE CONTROL SYSTEM

(75) Inventors: KUO-CHIANG CHIANG, New Taipei City (TW); MING-CHUNG HUNG, New Taipei City (TW); JIUN-SHIN WU, New Taipei City (TW)

(73) Assignee: AVERMEDIA INFORMATION, INC., New Taipei City (TW)

(21) Appl. No.: 13/038,219

(22) Filed: Mar. 1, 2011

(51) Int. Cl. G09G 5/00

(52) U.S. Cl. 345/629

(57) ABSTRACT

An exemplary image control method is adapted for an image control system including a document camera and a first user device. In the image control method, the document camera generates a first image and provides the first image to the first user device for display. The first user device then produces a control information in response to an operation performed on the first image displayed on the first user device. After that, the first image is transformed into a second image. Finally, the first user device displays the second image.

### FIELD OF THE INVENTION

The present invention generally relates to an image control method and an image control system, and more particularly to a method and a system associated with using a user device to perform an image control on an image provided from a document camera.

### BACKGROUND OF THE INVENTION

Generally, when enterprises, schools or some seminars make a presentation, a conference or a lecture, a document camera usually is used to assist the conference or lecture. In particular, after a lens of the document camera capture images of planar objects such as some physical documents or pictures even three-dimensional objects, the captured images then are transmitted to a display device. By use of the display function of the display device, the user can watch digital images of the objects. In addition, the document camera can be used with a network together to transmit the images of the objects to users in different locations for viewing.

Referring to FIG. 1, a schematic functional block diagram associated with a document camera 13 transmitting an image of an object 11 to a display device 15 for display is illustrated. In particular, the user operating the document camera 13 firstly observes the object 11, and then uses the document camera 13 to generate a digital image of the object 11. After that, the information associated with the digital image is sent to the display device 15 signally connected with the document camera 13.

The conventional document camera 13 can provide the presenter with a human machine interface for operation by a touch panel 131 equipped on the document camera 13, besides using the display device 15 to share all participants with the digital image, and therefore other users attending the conference or course can simultaneously watch operation status of writing and/or drawing on the touch panel 131 built in the document camera 13 through the display device 15. In other words, by the use of the touch panel 131, the result of an operation performed on the displayed image of the object 11 by the presenter can be sent to the display device watched by the other participants.

Although the conventional method has provided an edit function to the image of the object 11 captured by the document camera 13, such conventional method still has some drawbacks. For example, the presenter must be near the document camera 13, so as to conveniently operate the touch panel 131 provided on the document camera 13.

Besides the drawback of the user's position being limited by the touch panel 131, if such conventional method is used in a video conference, the sharing of the image of the object 11 is a one-to-multiple manner. That is, the other participants only can passively acquire the image of the object 11 and thus could not interact with the conference host; even though the other participants want to join into the discussion, the other participants only can announce their opinions with respect to the image of the object 11 by oral expression, for example, an oral expression such as ┌what is the meaning of the second small icon on the top right corner of the object A counted from top to bottom?┘ or like is adopted to describe the place wanted to ask or discuss. In the situation of discussion being inconvenient, such conventional method would result in the presenter only can make a lecture in the conference to the other participants in a monodirectional manner, so that the other participants in the conference are passive and therefore the participants could not interact with each other.

In other words, in the conventional method, not only the location of the presenter is limited, but also the operation mode of the document camera 13 takes the conference host or presentation lecturer as the center, which results in the other participants could not interact with the lecturer aiming at the image of the object 11, so that the effect of carrying out the conference or course by using the document camera 13 is poor.

It is found from the above description that the conventional method could not achieve the effects of information exchange and sharing in the situation of the document camera 13 being used for carrying out a multiple people and remote conference. Accordingly, the present invention is developed to achieve the purpose of overcoming the drawbacks in the prior art and making the user to operate the document camera more convenient.

### SUMMARY OF THE INVENTION

Therefore, in one aspect, the present invention provides an image control method applied to a document camera and a first user device. The image control method includes the following steps of: generating a first image by the document camera and providing the first image to the first user device for display; producing a control information by the first user device in response to an operation performed on the first image displayed on the first user device; transforming the first image into a second image according to the control information; and displaying the second image by the first user device.

According to the above inventive conception, the image control method can further include the following steps of: separately receiving the first image and the control information by a second user device; and then displaying the second image by the second user device.

According to the above inventive conception, the image control method can further include the following step of: receiving and displaying the second image by a second user device.

According to the above conception, the image control method can further include the following steps of: providing a first operation request and a second operation request respectively by the first user device and the second user device; and determining the first user device to be given a master rights in response to the first and second operation requests.

According to the above inventive conception, in the image control method, the step of determining the first user device to be given a master rights in response to the first and second operation requests can be carried out by a servo process. The servo process can be performed by the document camera, the first user device, the second user device or a servo device.

According to the above inventive conception, in the image control method, the step of producing a control information by the first user device in response to an operation performed on the first image displayed on the first user device can include the following sub-steps of: providing an user interface; performing an edit operation on the first image through the user interface; and transforming a content associated with the edit operation into the control information.

According to the above inventive conception, in the image control method, the step of transforming the first image into a second image according to the control information can be performed by the document camera or the first user device.

In another aspect, the present invention provides an image control system. In particular, the image control system includes a document camera and a first user device. The document camera is for generating and providing a first image. The first user device is signally connected with the document camera and for producing a control information in response to an operation performed on the first image after receiving and displaying the first image. Moreover, the control information is transmitted from the first user device to the document camera, and further the first user device transforms the first image into a second image according to the control information.

According to the above inventive conception, the image control system can further include a second user device. The second user device is signally connected with both the document camera and the first user device and further for receiving and displaying the second image.

According to the above inventive conception, the image control system can further include a second user device. The second user device is signally connected with both the document camera and the first user device. Moreover, the second user device receives the first image and the control information separately and then transforms the first image into the second image according to the control information and further displays the second image.

According to the above inventive conception, in the image control system, the first user device and the second user device respectively provide a first operation request and a second operation request, and the first and second operation requests are used to determine the first user device to be given a master rights by a servo process.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic functional block diagram associated with a document camera transmitting an image of an object to a display device for display in the prior art.

FIG. 2A is a schematic functional block diagram of an image control system of the present invention.

FIG. 2B is a schematic functional block diagram of an image control system of the present invention including multiple user devices.

FIG. 2C is a schematic process view of transforming a first image into a second image according to a control information.

FIG. 3A is a flow chart of an image control method of the present invention applied to an image control system including a document camera and a first user device.

FIG. 3B is a schematic detailed process map of flow chart of producing a control information in response to an operation performed on a first image displayed on a first user device.

FIG. 3C is a schematic data flow diagram of an image control method of the present invention adapted for a document camera and a first user device.

FIG. 4A is a schematic flow chart of an image control method of the present invention adapted for a document camera, a first user device and a second user device.

FIG. 4B is a schematic data flow diagram of an image control method of the present invention applied to a situation that when a document camera, a first user device and a second user device are equipped, a first image provided by the document camera and a control information provided by the first user device are separately transmitted to the second user device, and then the second user device transforms the first image into a second image according to the control information.

FIG. 4C is a schematic data flow diagram of an image control method of the present invention applied to another situation that when a document camera, a first user device and a second user device are equipped, a control information and a first image are transmitted together as a form of a second image transformed from the first image according to the control information.

FIG. 5A is a schematic flow chart of initialization stage of a first user device, a document camera and a second user device in an image control system in accordance with an embodiment of the present invention.

FIG. 5B is a schematic flow chart associated with a first user device, a document camera and a second user device in an image control system after entering into an image display mode, in accordance with an embodiment of the present invention.

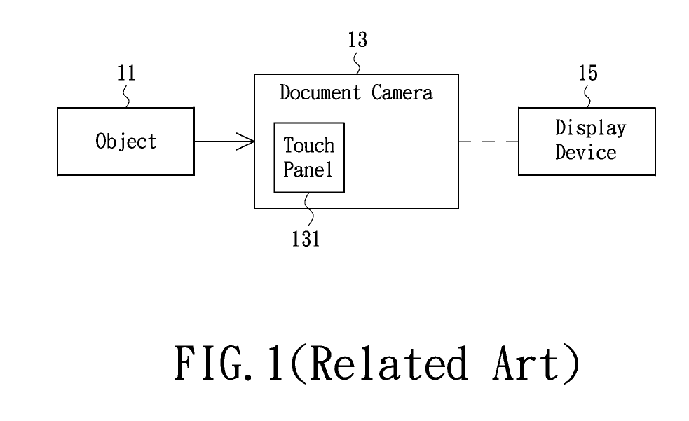

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

It is found from the above description associated with the prior art that, the document camera using the conventional technology would have the disadvantages that: the conference director/course lecturer is limited by the location of the document camera during performing an operation on an image of object, and the application manner of the document camera results in insufficient of interaction during the conference. Accordingly, the present invention expects to achieve the purpose of overcoming the drawbacks in the prior art and making the application of the document camera be more flexible.

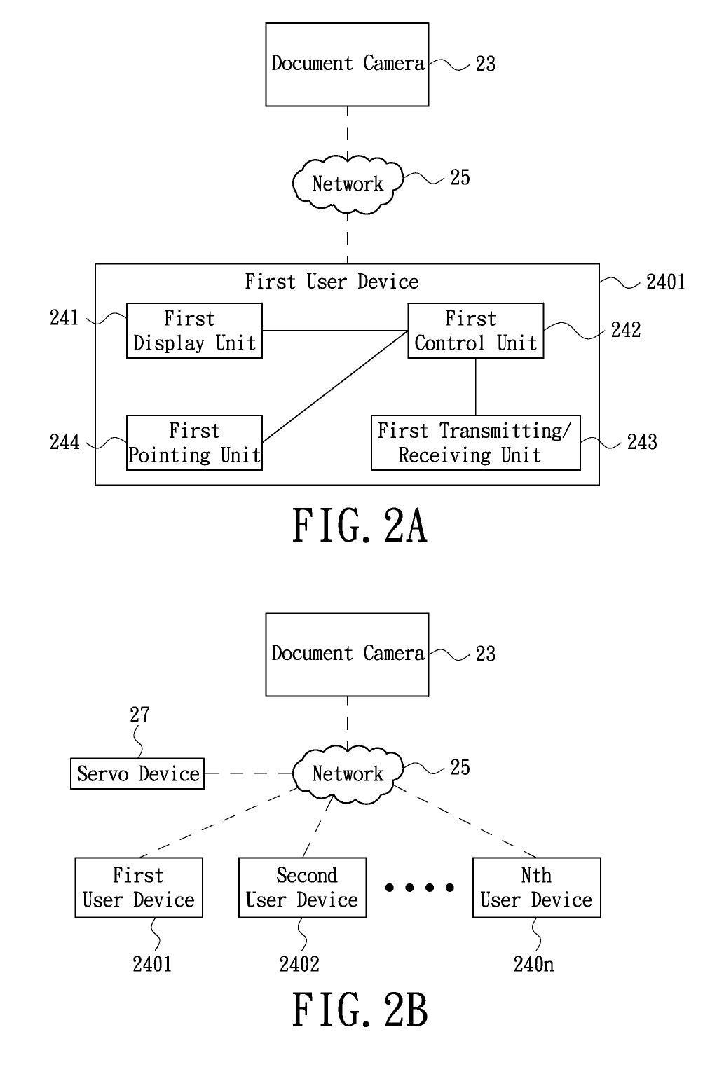

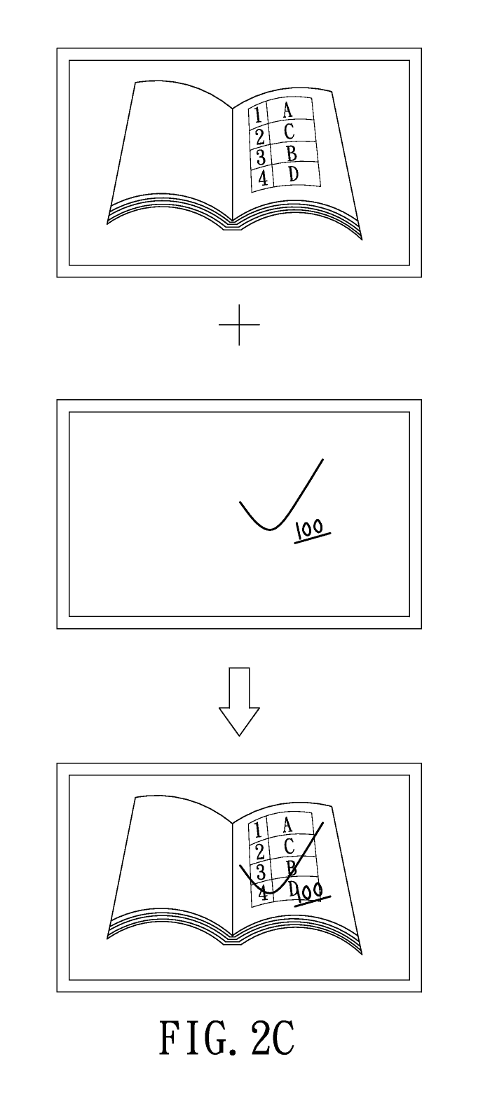

Referring to FIG. 2A, a schematic functional block diagram of an image control system in accordance with an embodiment of the present invention is shown. The image control system includes a document camera 23 and a first user device 2401. The document camera 23 is for generating and providing a first image. The first user device 2401 is signally connected with the document camera 23.

It is noted that, although a network 25 in FIG. 2A is taken as a data transmission media between the document camera 23 and the first user device 2401, in actual applications, the signal connection manner between the document camera 23 and the first user device 2401 is not limited to this, and can be carried out by a data line, a wired/wireless network and so on.

An implementation of the image control system in use is that: firstly the document camera 23 is used to capture an object (not shown), and then the document camera 23 generates and provides a first image; the first user device 2401 receives the first image transmitted from the document camera 23 and then uses a first display unit 241 to display the first image.

Although the aspect of the first user device 2401 receiving the first image is similar to that in the prior art, the function of the first user device 2401 in the present invention is not limited to receive and display the first image. The use of the first user device 2401 can actively edit the first image. After the first user device 2401 obtains a control information corresponding to the edit operation, the first user device 2401 transmits the control information and/or a correspondingly-generated second image to other device(s) in the image control system, and thereby achieving the purpose of using the user device to perform the edit operation and then sharing the content associated with the edit operation to the other device(s) in the image control system.

Put simply, an operator of the first user device 2401, after viewing the first image, if wants to announce his opinion as to the first image, the operator can provide a function of displaying user interface or edit operation, etc. on the first user device 2401, besides the traditional oral expression. Furthermore, the operator can provide a cursor mark function to allow the user to control the movement of the cursor by a pointing unit (e.g., the first pointing unit 244), which facilitates the achievement of circling different regions of the first image according to the movement traces of the cursor.

Moreover, by the assist of software, the above various types of edit operations can be transformed into control information, and the first image then is transformed into the second image by superimposing the image with a result of the trace operation or the edit operation.

After the first user device 2401 obtains the control information, the manner of how to share the control information with other device(s) in the image control system is considerably diversified. In summary, the variants of such application manner are caused based on different focuses of attention being in consideration, but whatever the focuses of attention may be, such variants would not influence the core conception of how to use the user devices to share control information proposed by the present invention.

For instance, a first focus of attention may be the manner of transmitting the first image and the control information, that is, either the manner of separately transmitting the first image and the control information, or the manner of transmitting the transformed second image is used. A second focus of attention may be the functions of device, e.g., the document camera 23 or the first user device 2401 is used as a servo device 27 for transmitting data and executing a servo process.

In order to focus the description in the subsequent preferred embodiments on how to apply the conception of the present invention, the subsequent discussion will not illustrate detailed changes in various different system architectures, but as far as the core conception of the present invention is concerned, such changes still are based on the same conception, i.e., allowing the operation performed on the user device to be transformed into a control information and then sharing the control information to various devices in the image control system.

It is found from FIG. 2A that, the first user device 2401 primarily includes a first display unit 241 and a first control unit 242 electrically connected with each other. The first display unit 241 is used to display a first image, a second image and a user interface. The control unit 242 is used to transform an edit operation performed on the user interface by a user into a corresponding control information.

Besides the first display unit 241 and the first control unit 242, the first user device 2401 can further include a first transmitting/receiving unit 243 and a first pointing unit 244. The first transmitting/receiving unit 243 is externally signally connected to the document camera 23 and internally signally connected to the first control unit 242. The first transmitting/receiving unit 243 is for receiving the first image transmitted from the document camera 23 and sending the control information generated by the first control unit 242 or the second image transformed from the first image by the first control unit 242 according to the control information to other device(s) in the image control system.

In another aspect, the first pointing unit 244 is electrically connected to the first control unit 242 and controls the first display unit 241 by the first control unit 242 to provide the user interface for the user to operate the first user device 2401. In other words, the first control unit 242 firstly controls the first display unit 241 by software procedure to display some edit tools such as painting brush, color modifier and annotation, to allow the user operating the first user device 2401 to edit the first image by the first pointing unit 244.

Once the first control unit 242 receives an edit command sent from the first pointing unit 244 being operated by the user, the first control unit 242 transforms a content corresponding to the edit command into a control command and then transmits the control command to the first display unit 241, to allow the image displayed on the first display unit 241 to be added with the content edited by the user besides the original first image. In other words, the image displayed on the first display unit 241 in this moment no longer is the original first image transmitted from the document camera 23 which only contains the image of object, and has transformed into a second image containing the control information such as the edit operation.

In actual applications, the first user device 2401 is a type of broad term, and therefore the appearance of the first user device 2401 does not influence the inventive conception of the present invention. For example, the first user device 2401 may be a computer or a mobile phone. In order to describe various units included in the first user device 2401 in more detailed, the mobile phone is taken as an example below to illustrate the uses of the first display unit 241, the first control unit 242, the first transmitting/receiving unit 243 and the first pointing unit 244.

In particular, when the mobile phone is taken as the first user device 2401, the first display unit 241 is a screen, the first control unit 242 is a micro-processor inside the mobile phone, the first transmitting/receiving unit 243 may be a function module transmitting/receiving data by global system for mobile communications (GSM) signal or wireless network access function, and the first pointing unit 244 may be a keyboard or a touch screen of the mobile phone.

Therefore, the user firstly can view the first image provided from the document camera 23 through the touch screen. The first control unit 242 in this situation can use the touch screen to provide a user interface, for example displaying the cursor on the image with a pen-shaped appearance. The trace of the cursor can be changed along with an operation performed by the user using buttons to give directions or a touch operation of the user sensed by the touch screen. After obtaining the operation performed by the user on the first image, the micro-processor then uses the displacement information of such cursor to produce a corresponding control information. Thereafter, the control information is transmitted to the document camera 23 through the first transmitting/receiving unit 243.

As far as the control information transmitted from the first user device 2401 is concerned, after the control information is transmitted to the document camera 23, the document camera 23 then transforms the first image into the second image according to the control information. Subsequently, the second image can be sent to other user device(s) for use.

Besides the mobile phone, the first user device 2401 can be a personal computer or a personal digital assistant (PDA) instead. In this circumstance, regardless of the types of the first user device 2401, the inventive conception of the present invention is to allow the first user device 2401 to execute the edit operation on the first image and then the control information corresponding to such edit operation can further be sent to the document camera 23 or other user device(s), so that the information exchange in the image control system can be more diversified rather than only limited to be the image provided by the document camera 23.

The first transmitting/receiving unit 243 in the first user device 2401 can provide the control information generated in response to the edit operation performed by the user on the first user device 2401 separated from or together with the first image to the image control system for use, besides receiving the first image transmitted from the document camera 23. As to approaches of generating the second image by the first user device 2401 according to both the first image and the control information, the approaches can be classified into two major types according to the generation manners of the second image.

A first type of approach is that after using the first transmitting/receiving unit 243 to transmit the control information to other devices e.g., the document camera 23 or a second user device 2402 and an Nth user device 240n in the image control system, such devices will transform the first image into the second image according to the control information. Compared with the first type of approach that the first image and the control information are separately transmitted, a second type of approach is that firstly using the first user device 2401 to transform the first image into the second image according to the control information, and then transmitting the second image to the other devices in the image control system from the first user device 2401.

Referring to FIG. 2B, a schematic functional block diagram of an image control system including multiple user devices in accordance with an embodiment of the present invention is shown. It is found from FIG. 2B that, in the image control system, the amount of the use devices used together with the document camera 23 is without limit, so that the document camera 23 can share the image and control information with the first user device 2401, second user device 2402, . . . , Nth user device 240n through a network 25.

When the image control system has multiple user devices, the situation of multiple user devices simultaneously performing operations on the first image ought to be taken in consideration, and therefore a servo process is necessary to be provided in the image control system. The servo process can determine which one of the user devices or the document camera 23 to have the master rights in different time points or conditions according to an order of operation requests provided by the respective user devices or preset operation priorities. Since the implement of the servo process can be carried out by software, in the situation of efficiency and resource of an individual device is sufficient, the servo process can be provided by the document camera 23 or one of the user devices in the image control system. In another aspect, the servo process can be provided by a dedicated servo device 27 instead, so as to reduce the running load of the respective devices in the image control system.

Referring to FIG. 2C, a schematic process view of transforming a first image into a second image according to a control information is shown. The top-most drawing in FIG. 2C represents a first image of a piece of student's work captured by the document camera 23. When the document camera 23 transmits the first image by the network 25 to the first user device 2401 operated by a teacher, the teacher can perform the edit operation such as annotation operation on the student's work through a user interface such as the image editor provided by the first user device 2401, besides viewing the first image. The first control unit 242 inside the first user device 2401 then transforms the edit operation performed by the teacher into a corresponding control information. By the use of the control information, the first image can be transformed into a second image containing the contents of student's work and teacher's annotation.

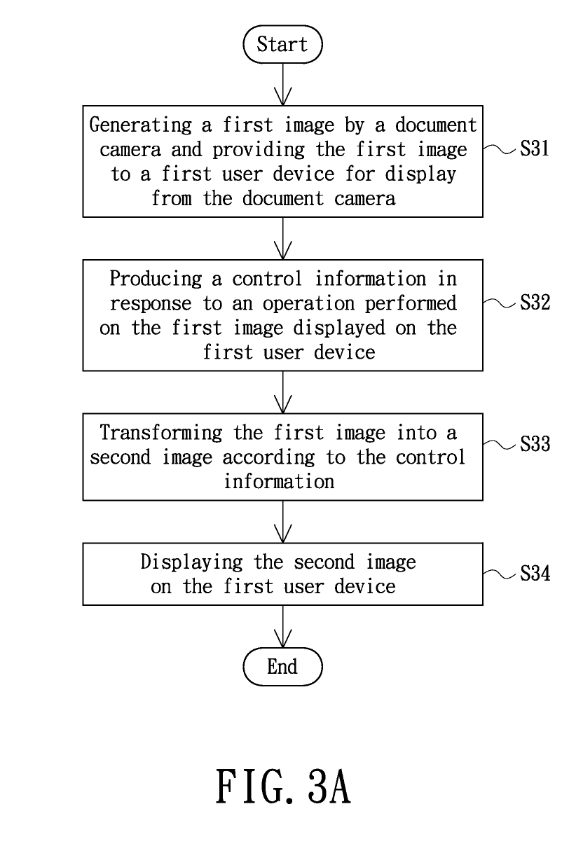

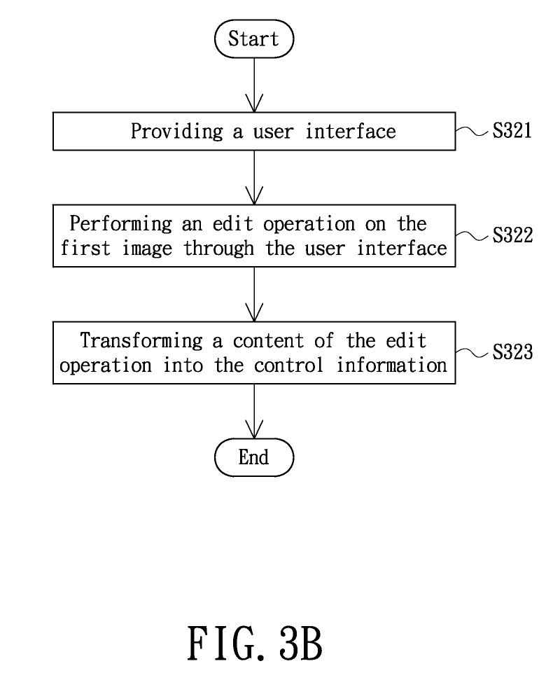

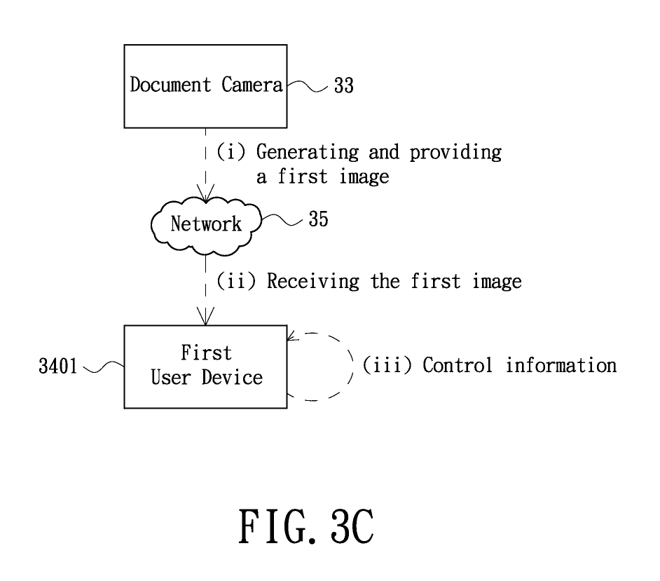

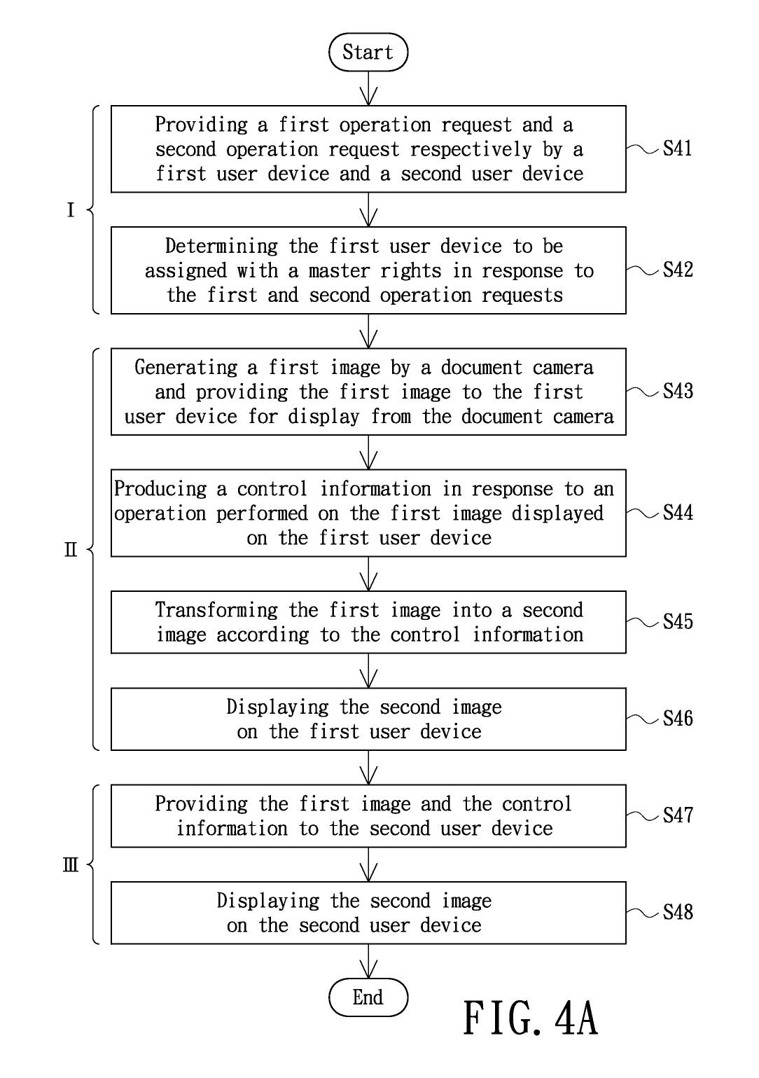

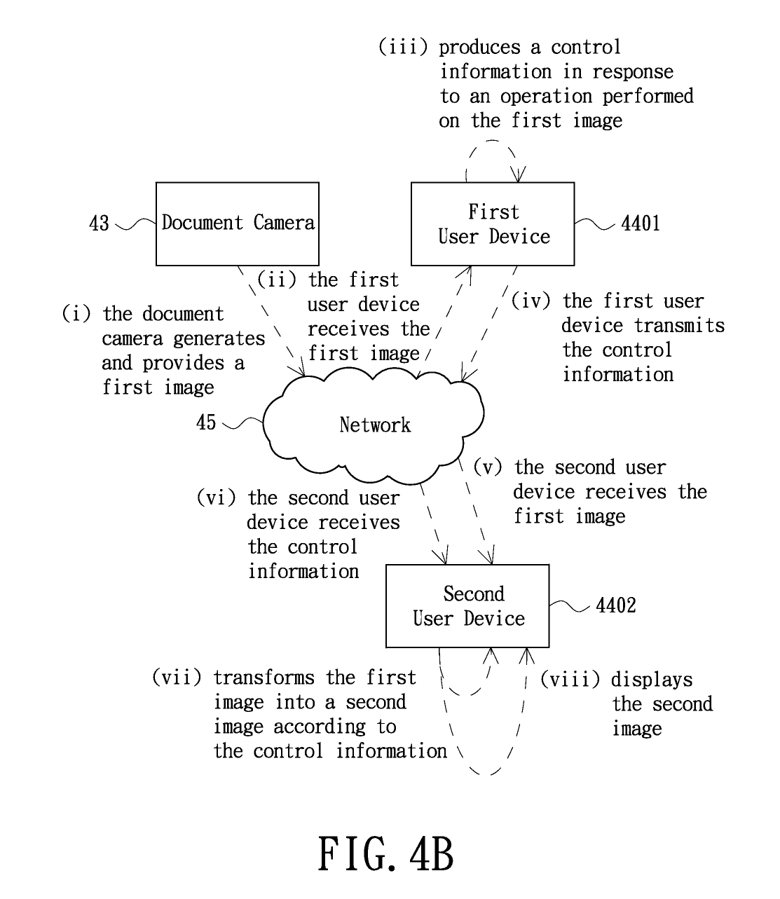

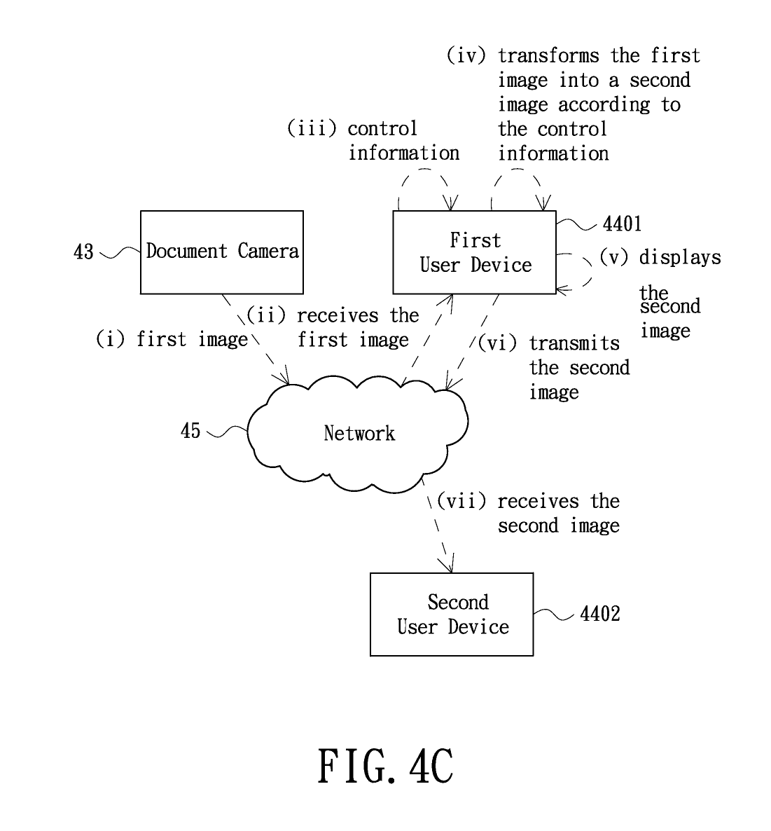

In order to describe the inventive conception of the present invention in more detailed, FIGS. 3(a), 3(b) and 3(c) firstly are made as a reference to illustrate that: when the image control system only include the document camera 23 and the first user device 2401, how to use the document camera 23 to allow the control information generated by the first user device 2401 to be sent back to the document camera 23, and allow the operator at the document camera side to acquire the operation status of the user operating the first user device 2401. Subsequently, FIGS. 4(a) and 4(b) are used to illustrate how to realize the transmitting and receiving of the image and control information in the circumstance of the image control system including the document camera 23 and two user devices (e.g., the first user device 2401 and the second user device 2402).

It is noted that, the preferred embodiments with reference to FIGS. 3(a), 3(b), 3(c) and FIGS. 4(a), 4(b) only describe the image control method of the present invention is applicable in the situations of having single one user device and multiple user devices respectively, arrangements of detailed process and devices included in the image control system can be flexibly changed or modified. For example, it is assumed that the servo process is provided by the document camera 23 in the following drawings, and furthermore, the user device given the master rights is assumed as the first user device 2401 for the purpose of simplifying the illustration. However, in actual applications, the master rights is not limited to give the first user device 2401, any one of the user devices and the document camera 23 in the image control system can obtain the master rights in different times.

Moreover, the content of the image received by the user device from the document camera 23 through the network 25 is without limit. For example, the first image can be obtained by dynamically capturing an object (not shown). In other embodiment, a source of the first image can be a previously-obtained image stored in a storage device (e.g., a memory card) and/or a memory built in the document camera 23 and then readout by the document camera 23.

A first situation may be that when the presenter takes an object in hand as an example to make a presentation to the other participants, all the participants can instantly see the operation result on the object caused by the presenter operating the document camera 23. A second situation may be that after the user using the document camera 23 to observe the object for a long time at the first, images at some time points are captured by an assist edit function provided by software, for example, as to a twenty-four hours observation for the growth of a plant, the course only needs images captured in each integer hour of the observation period to compare the growth status of the plant-under-observation in one week, and thus there is no need to play all the images captured in the observation period.

Referring to FIG. 3A, a schematic flow chart of an image control method applied to an image control system including a document camera 33 and a first user device 3401 in accordance with an embodiment of the present invention. In this preferred embodiment, the image control method is applied between the document camera 33 and the first user device 3401, and major steps of the image control method will be described below in detailed.

Firstly, the document camera 33 generates a first image and provides the first image to the first user device 3401 for display (step S31), a control information then is produced in response to an operation performed on the first image displayed on the first user device 3401 (step S32). After that, the first image is transformed into a second image according to the control information (step S33), and then the first user device 3401 displays the second image (step S34).

Referring to FIG. 3B, a schematic detailed process map of flow chart of producing the control information in response to the operation performed on the first image displayed on the first user device 3401 is shown. In terms of the step S32 in FIG. 3A, it further can be divided into several sub-steps of: providing a user interface by software (step S321), performing an edit operation on the first image through the user interface (step S322), and transforming a content associated with the edit operation into the control information (step S323).

Referring to FIG. 3C, a schematic data flow diagram of an image control method of the present invention adapted for the document camera 33 and the first user device 3401 is shown. In order to clearly illustrate communications and data flows between the devices, numbers are used to indicate the generation process of the image and the control information and how the data to be transmitted and received between the devices.

In the image control system as illustrated in FIG. 3C, the generation and use of the data can be primarily divided into the following three steps of: (i) using the document camera 33 to generate and provide a first image, (ii) receiving and displaying the first image provided from the document camera 33 by the first user device 33 signally connected with the document camera 33 by any type of network 35, and (iii) once the user performs an operation on the first user device 3401, producing a control information by the first user device 3401 in response to the operation on the first image and transforming the first image into a second image for display according to the produced control information.

Referring to FIG. 4A, a schematic flow chart of an image control method of the present invention applied in an image control system including a document camera 43, a first user device 4401 and a second user device 4402 is shown. Compared with FIG. 3A, the image control system is added with the second user device 4402, so that related steps are additionally added with respect to the image control system only equipped with the first user device 4401. Steps of the following described control method can be classified into three types I˜III according to different natures.

In particular, steps in the type I are a servo process for receiving operation requests transmitted from the respective user devices and distributing the master rights and slave rights. Steps in the type II are similar to that in the situation of the image control system only equipped with the first user device 4401. Steps in the type III are a process associated with that the second user device 4402 given with the slave rights displays a second image in response to both the first image provided from the document camera 43 and the control information produced from the first user device 4401.

It is noted that, the purpose of classifying the steps in the control process according to the natures only is for the convenience of description, the order of such steps are without limit. For example, steps S41 and S42 in the type I can be performed during the system initialization, or is performed after the step S43 instead.

More specifically, the steps in the type I include that providing a first operation request and a second operation request respectively by the first user device 4401 and the second user device 4402 (step S41), and determining the first user device 4401 to have the master rights in response to the first and second operation requests (step S42). With respect to the first user device 4401 given with the master rights, the second user device 4402 is assigned with the slave rights. Whereas, if the second user device 4402 is given the master rights, the first user device 4401 would be assigned with the slave rights.

The steps in the type II include that: generating a first image and providing the first image to the first user device 4401 for display by the document camera (step S43), producing a control information by the first user device 4401 in response to an operation performed on the first image displayed on the first user device 4401 (step S44), transforming the first image into a second image according to the control information (step S45), and displaying the second image by the first user device 4401 (step S46).

The steps in the type III include that: providing the first image and the control information to the second user device 4402 (step S47), and displaying the second image by the second user device 4402 (step S48).

Moreover, according to different system architectures, the step S47 of providing the first image and the control information to the second user device 4402 may be that the second user device 4402 uses the control information to transform the first image into the second image after receiving the first image and the control information separately, or the second user device 4402 directly receives and displays the second image which has been transformed from the first image in other device of the image control system according to the control information.

As to the steps in the type I, after the step of receiving the first operation request and the second operation request, the step of determining one of the user devices to have the master rights can be carried out by a servo process. Since the servo process can be completed by software, the servo process can be performed by the document camera 43, the first user device 4401, the second user device 4402 or a dedicated servo device. As to the assignment result of master rights and slave rights according to the operation requests provided by the user device, it can be dynamically adjusted. For example, a password authentication is used to determine which one of the user device is allowed to operate at the beginning; or an alternate sensing process is used to sense all the user devices, and if it is found that the user is using a pointing unit on the first user device 4401 to perform an operation during the sensing process, the master rights is assigned to the first user device 4401.

In addition, if multiple user devices simultaneously provide operation requests at a same time point, the issue of operation requests conflict may be caused, therefore it is necessary to provide a sorting method to determine the processing order of the control information transmitted from the respective user devices. The realization of the sorting method is without limit. For example, one type of sorting method is to provide a temporary memory space for the use of sorting sequence, i.e., sorting is made according to a provision order of the operation requests for the user devices. It is assumed that the first user device 4401 is first to provide a first operation request and the second user device 4402 provides a second operation request subsequently, if the first operation request is not finished, the second operation request provided by the second user device 4402 would be temporarily stored in a temporary memory space to form a sorting sequence and then a corresponding operation is performed according to the second operation request provided by the second user device 4402 after the first operation request provided by the first user device 4401 is finished.

Another type of sorting method may be that priorities of the respective user devices are used. When the user device with a relatively high priority sends an operation request, the user device assigned with the master rights previously would give up the master rights because of its relatively low priority and then receive the control information produced from the other user device(s). Such case may occur during using the image control system for teaching. It is assumed that the image control system is designed to assign the highest priority to the teacher operating the first user device 4401, while the student operating the second user device 4402 only can announce his opinion until the teacher finishes the lecture.

The step S44 can be, similar to the step S21, further divided into sub-steps of: providing a user interface, performing an edit operation on the first image through the user interface, and transforming a content associated with the edit operation into the control information. Such sub-steps are irrelevant with the amount of the user devices in the image control system, but the sub-steps generally are performed by the user device assigned with the master rights. In this embodiment, the first user device 4401 acts as the user device assigned with the master rights, but in other situation, the second user device 4402 would be given the master rights to provide the user interface and perform the edit operation on the first image through the user interface provided by the second user device 4402.

In terms of the servo process, since the image control system herein includes multiple user devices, the servo process can be used to determine which one of the user devices would be given the master rights. Since a conference can be performed in an interactive manner, the user devices with the master rights or the slave rights can be switched according to the need of the operation process, so that the master rights is taken turns among the user devices.

Besides the implementation of the servo process is provided by the document camera 43, the servo process can be provided by a fixed one of the user devices instead. The servo process can be used to determine which one of the user devices has the master rights and which one of the user device only has the slave right and further can be used to collect and deliver related control information and images, so as to lighten the load of the other user device. In this situation, the device for providing the servo process can be any one of the user devices (e.g., the user device having the best system efficiency), or a dedicated servo device.

Referring to FIG. 4B, a schematic data flow diagram of an image control method of the present invention is shown. Herein, the image control method is applied in the situation that when the image control system includes the document camera 43, the first user device 4401 and the second user device 4402, the first image provided by the document camera 43 and the control information provided by the first user device 4401 are separately transmitted to the second user device 4402, and then the second user device 4402 transforms the first image into a second image according to the control information.

For the convenience of illustrating the data flow directions among the document camera 43, the first user device 4401 and the second user device 4402, arrows and numbers are used below to represent directions and orders of the data generated from the respective devices.

In FIG. 4B, (i) the document camera 43 firstly generates and provides a first image; (ii) the first user device 4401 receives the first image through a network 45; (iii) the first user device 4401 produces a control information in response to an operation performed on the first image by a user; (iv) the first user device 4401 sends out the control information; (v)&(vi) the second user device 4402 receives the first image and the control information through the network 45, herein the receiving orders of the first image and the control information are without limit; (vii) the second user device 4402 transforms the first image into a second image according to the control information; and (viii) the second user device 4402 displays the second image.

The purpose of providing the illustration of FIG. 4B primarily is to describe the process of the second user device 4402 obtaining and displaying the second image. In other embodiments, the first user device 4401 also can transform the first image into the second image according to the control information for display. Likewise, the document camera 43 can receive the control information from the first user device 4401 by the network 45 and then provide the function of transforming the first image into the second image; such embodiments will not be illustrated herein for the purpose of simplifying description.

Referring to FIG. 4C, a schematic data flow diagram of an image control method of the present invention is provided. Herein, the image control method is applied in the situation that when an image control system includes the document camera 43, the first user device 4401 and the second user device 4402, the control information and the first image are transmitted in combination in the form of a second image transformed from the first image according to the control information.

For the convenience of illustrating data flow directions among the document camera 43, the first user device 4401 and the second user device 4402, arrows and numbers are used in FIG. 4C to represent directions and orders of generating and transmitting data.

In FIG. 4C, (i) the document camera 43 firstly generates a first image; (ii) the first user device 4401 receives the first image through the network 45; (iii) the first user device 4401 produces a control information in response to an operation performed on the first image by a user; (iv) the first user device 4401 transforms the first image into a second image according to the control information; (v) the first user device 4401 displays the second image; (vi) the first user device 4401 transmits the second image onto the network 45; and (vii) the second user device 4402 receives the second image through the network 45.

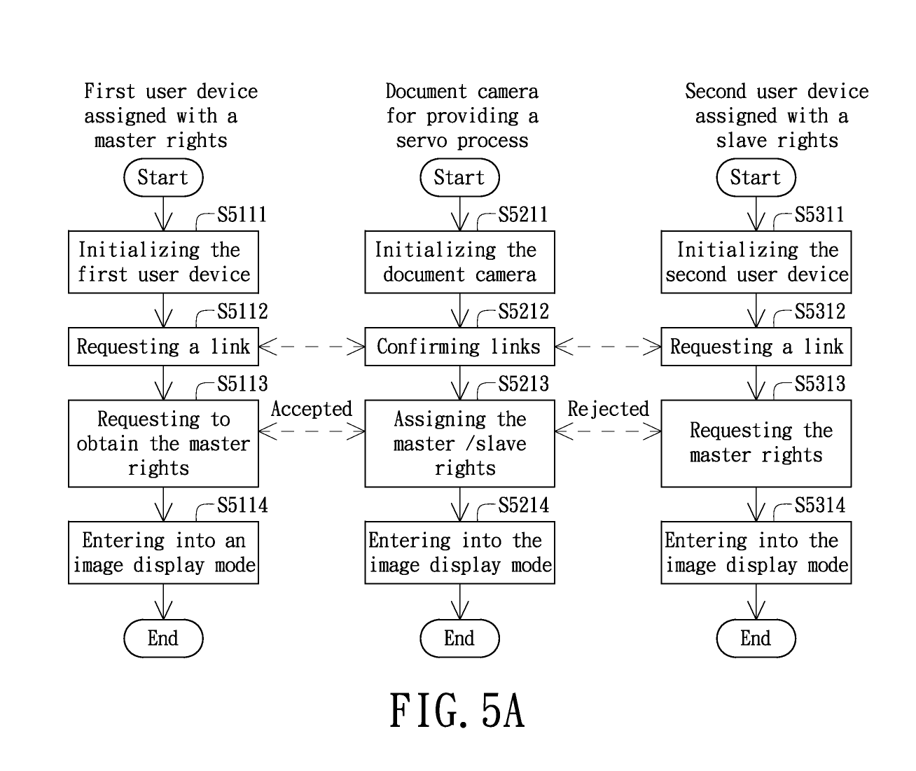

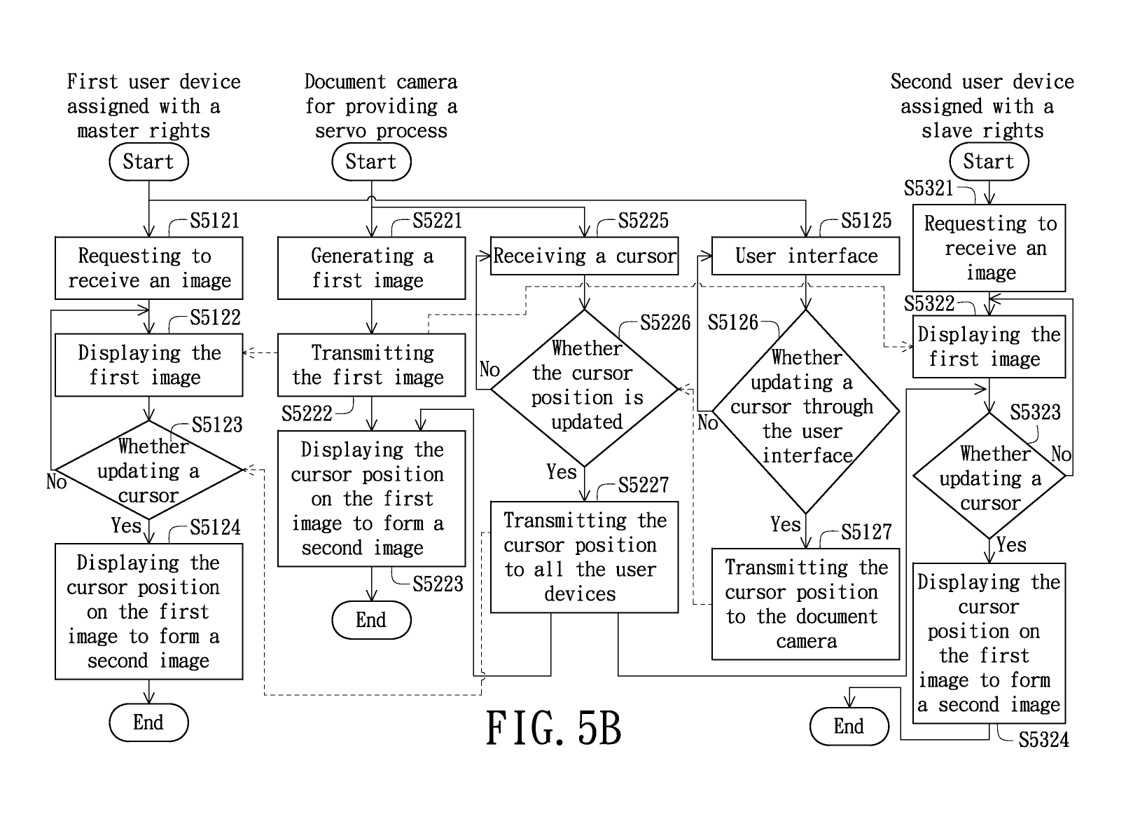

In order to more clearly illustrate the inventive conception of the present invention, the illustrations in FIGS. 5(a) and 5(b) are taken as examples to describe the operation steps in the respective devices of the image control system and the relative relationships among the steps. Herein, it is assumed that the servo process is provided by the document camera in an initialization stage at the beginning, the control information and the first image are separately transmitted to allow an individual user device to perform an image transformation process after receiving both the control information and the first image. In addition, in order to simplify the description of system process, in FIGS. 5(a) and 5(b), it is assumed that the first user device is given the master rights while the second user device is assigned with the slave rights, and further the master rights and slave rights are not exchanged during the transmission process of image.

Referring to FIG. 5A, a schematic flow chart of initialization stage of the first user device, the document camera and the second user device in the image control system is shown. Herein, the initialization stage is that at the beginning of a conference, the document camera or the user devices may need some boot settings and to establish links. The servo process for determining which one of the user devices is given the master rights and which of the user devices is given the slave right also can be set in the initialization stage.

Firstly, the process of the first user device given with the master rights during the initialization stage is described. In particular, in the step S5111, the first user device is initialized; in the step S5112, a link request is sent to the document camera; in the step S5113, a request for obtaining the master rights is sent out after establishing the link; and in the step S5114, the first user device enters into an image display mode.

Subsequently, the process of the document camera during the initialization stage is described. In the step S5211, the document camera is initialized; in the step S5212, the document camera confirms the link requests from the first user device and the second user device; in the step S5213, the document camera assigns the master rights or the slave rights to the multiple user devices requesting the master rights; and in the step S5214, the document camera enters into the image display mode.

Finally, the process of the second user device assigned with the slave rights during the initialization stage is described. In the step S5311, the second user device is initialized; in the step S5312, a link request is sent out; in the step S5313, the second user device requests to obtain the master rights; and in the step S5314, the second user device enters into the image display mode.

In this embodiment, the first user device being assigned with the master rights prior to the second user device is taken an example, to allow the document camera to accept the request of the first user device for obtaining the master rights while rejects the request of the second user device for obtaining the master rights. In another embodiment, the second user device can be assigned with the master rights at the first, and the first user device is given the master rights only after the second user device finishes the operation required the master rights.

Referring to FIG. 5B, a schematic flow chart associated with the first user device, the document camera and the second user device in the image control system after entering into the image display mode is shown. Herein, the process is equivalent to an operation process of an individual device (including the user devices and the document camera) during a conference in progress.

Firstly, a process of the first user device assigned with the master rights entering into an image transmission mode is described. In particular, the first user device requests to receive an image (step S5121); the first user device then displays a first image after receiving the first image from the document camera (step S5122) and meanwhile provides a user interface to the user for operation (step S5125); after that, the first user device judges the user whether needs to update a cursor through the user interface by operating a pointing unit (step S5126). If the judge result is YES, a cursor position is transmitted to the document camera (step S5127), whereas if the judge result is NO, the user interface is maintained. In another aspect, the first user device can judge whether it is needed to update the cursor according to a message sent from the document camera (step S5123), if the judge result is YES, the updated cursor position is combined into the first image to form a second image (step S5124), whereas if the judge result is NO, the first user device purely displays the first image.

Secondly, a process of the document camera operated in the image transmission mode is described. In particular, the document camera captures an object to generate a first image (step S5221), then the first image is transmitted to the respective user devices (step S5222). In addition, the document camera can sense whether the user devices sends out control information or not and thus would receive the cursor position (step S5225), and then judges whether the cursor position is updated (step S5227). If the cursor position is updated, the updated cursor position would be sent to all the user devices (step S5227), and then a second image is formed after superimposing the updated cursor position on the first image displayed by the document camera and displaying the updated cursor position.

Finally, a process of the second user device assigned with the slave rights operating in the image transmission mode is described. In particular, the second user device requests to receive an image (step S5321) and then displays a received first image (step S5322). After that, the second user device judges whether it is needed to update the cursor position (step S5323), and if the judge result is YES, the updated cursor position is displayed on the first image and thereby obtaining a second image (step S5324).

In various embodiments of the present invention, besides that the user operating the first user device can be allowed to perform amendment or annotation operation on the first image on the assist of various types of pointing units as the user is viewing the first image transmitted from the document camera, and then the content associated with the amendment or annotation operation is superimposed on the first image to form the second image, the user(s) operating the other user device(s) also can join into the discussion. Accordingly, the drawback of insufficient interactivity associated with the conventional method can be improved.

In summary, the image control method in accordance with the present invention not only improves the drawback of that the conventional image control system only can provide the monodirectional communication function, but also can make the use of the document camera be more flexible.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image control method adapted for a document camera and a first user device, the image control method comprising:
generating a first image by the document camera and providing the first image from the document camera to the first user device for display;
producing a control information in response to an operation performed on the first image displayed on the first user device;
transforming the first image into a second image according to the control information; and
displaying the second image on the first user device.

2. The image control method according to claim 1, further comprising:
receiving the first image and the control information separately by a second user device; and
displaying the second image on the second user device.

3. The image control method according to claim 2, further comprising:
providing a first operation request and a second operation request respectively by the first user device and the second user device; and
determining the first user device to be assigned with a master rights according to the first and second operation requests.

4. The image control method according to claim 1, further comprising:
receiving and displaying the second image by a second user device.

5. The image control method according to claim 4, further comprising:
providing a first operation request and a second operation request respectively by the first user device and the second user device; and
determining the first user device to be assigned with a master rights according to the first and second operation requests.

6. The image control method according to claim 5, wherein the step of determining the first user device to be assigned with a master rights according to the first and second operation requests is performed by a servo process, and the server process is executed by the document camera, the first user device, the second user device or a servo device.

7. The image control method according to claim 1, wherein the step of producing a control information in response to an operation performed on the first image displayed on the first user device comprises:
providing a user interface;
performing an edit operation on the first image through the user interface; and
transforming a content of the edit operation into the control information.

8. The image control method according to claim 1, wherein the step of transforming the first image into a second image according to the control information is performed by the document camera or the first user device.

9. An image control system comprising:
a document camera, for generating and providing a first image; and
a first user device, signally connected with the document camera and for receiving and displaying the first image and then producing a control information in response to an operation performed on the displayed first image, wherein the control information is transmitted to the document camera from the first user device, the first user device further transforms the first image into a second image according to the control information and then displays the second image.

10. The image control system according to claim 9, further comprising:
a second user device, signally connected with both the document camera and the first user device and for receiving and displaying the second image.

11. The image control system according to claim 10, wherein the first user device and the second user device respectively provide a first operation request and a second operation request, and the first and second operation requests are used to determine the first user device to be given a master rights by a servo process.

12. The image control system according to claim 9, further comprising:
a second user device, signally connected with both the document camera and the first user device and for transforming the first image into the second image according to the control information and displaying the second image after receiving the first image and the control information.

13. The image control system according to claim 12, wherein the first user device and the second user device respectively provide a first operation request and a second operation request, and the first and second operation requests are used to determine the first user device to be given a master rights by a servo process.
